(19) United States
(12) Patent Application Publication
(10) Pub. No.: US 2002/0067950 A1
(43) Pub. Date: Jun. 6, 2002

(54) HVAC flange and flange machine

(76) Inventors: Miller S. Price, Morristown, TN (US); Mark A. Froning, Arden, NC (US); Gregory C. Moyers, Arden, NC (US)

Correspondence Address: Steven C. Schnedler, Carter & Schnedler, P.A., 56 Central Avenue, # 101, P.O.Box 2985, Asheville, NC, 28802, US

(21) Appl. No.: 09/728,845

(22) Filed: Dec. 1, 2000

Related U.S. Application Data
(60) Provisional application No. 60/168,498, filed on Dec. 2, 1999.

(51) Int. Cl. F16B 1/00; F16D 1/00; F16L 23/00

(52) U.S. Cl. 403/338

(57) ABSTRACT

A flange assembly for joining sections of round or flat oval ductwork, a corresponding method of use, and a machine for making. The flange is generally L-shaped in profile, and is made of a single piece of metal requiring only a single joint. The machine makes flanges from a single length of coiled steel stock.

### CROSS-REFERENCE TO PROVISIONAL PATENT APPLICATION

The benefit of U.S. provisional patent application Ser. No. 60/168,498, filed Dec. 2, 1999, is claimed.

### BACKGROUND OF THE INVENTION

The invention relates to the joining of sections of round (spiral) and flat oval ductwork, such as is employed in heating, ventilation and air conditioning (HVAC) system applications.

Two primary techniques are known for joining round (spiral) and flat oval ductwork.

With reference to FIGS. 1 and 2, the first known technique is to use a collar 20 that is slightly smaller in diameter than the ductwork sections 22 and 24 that are being joined. This collar 20 simply slides inside the ductwork sections 22 and 24, and is then fastened in place via sheet metal screws 26. This type of connection can be acceptable for small ductwork sizes at low pressures (diameters up to 30 inches and pressures less than 2 inches water column).

With reference to FIG. 3, the second known technique, commonly used on larger diameter and high-pressure duct, is to attach to the ends of each ductwork section 32, 34 to be joined respective angle iron flanges 36 and 38 that have been formed to a round shape via a set of powered rolls. The flanges 36 and 38 have L-shaped profiles defined by respective duct-attachment legs 40 and 42 extending generally parallel to the longitudinal axis of the ductwork sections 32 and 34 being joined, and by respective flange-attachment legs 44 and 46 extending radially outwardly generally perpendicularly to the longitudinal axis of the ductwork sections 32 and 34 being joined. The formed angle iron flanges 36 and 38 are fastened to the ductwork sections 32 and 34 via sheet metal screws in pre-drilled holes in the duct-attachment legs 40 and 42, or are welded at spot welds 48 directly to the ductwork sections 32 and 34. Pre-drilled holes 50 are provided in the flange-attachment legs 44 and 46 for bolting the flange sections 36 and 38 together. A sealant is applied to the seam between the ductwork and the angle iron flange, between the spot welds 48 if present. A gasket 52 or bead of sealant is applied to the faces of the flange-attachment legs 44 and 46. The two ductwork sections 32, 34 and angle iron flange 36, 38 assemblies are then fastened together with bolts and nuts.

For flat oval iron flange connections, the round angle iron flange 36, 38 is cut into two halves and two pieces 54, 56 of straight angle iron are welded between the half circles. This “flat oval” shaped flange can then be fastened to the ductwork 32, 34 via sheet metal screws in pre-drilled holes or welded directly to the ductwork 32, 34.

### SUMMARY OF THE INVENTION

In an exemplary embodiment of the invention, a connector, which may also be termed a flange assembly, for joining sections of flat oval ductwork takes the form of a pair of flat oval flanges that are generally L-shaped in profile. Each of the flanges is made of a single piece of metal requiring only a single joint.

A corresponding method embodying the invention for joining sections of flat oval ductwork includes the steps of providing a pair of flat oval flanges generally L-shaped in profile. Each of the flanges is made of a single piece of metal requiring only a single joint. The L-shaped profile is defined by a duct-attachment leg generally parallel to the longitudinal axis of the ductwork sections to be joined, and by a flange-attachment leg extending generally radially outwardly generally perpendicularly to the longitudinal axis of the ductwork sections to be joined. The flat oval flanges are inserted into the respective ends of the ductwork sections to be joined, and the duct-attachment legs are attached to the respective ductwork sections. The flange-attachment legs of the flat oval flanges are abutted against each other, preferably with an intermediate gasket, and are then fastened to each other, preferably employing clips.

A corresponding machine embodying the invention for making generally L-shaped flanges for joining sections of flat oval ductwork includes an input section for receiving a strip of sheet metal stock material, and a cutter for cutting the sheet metal stock material into lengths corresponding to individual flanges being made. The machine additionally includes a set of angle-forming rolls for forming each length of sheet metal stock material into an angled length material having a generally L-shaped profile, as well as a set of shaping rolls for forming the angle lengths of material into flat oval flanges, generally L-shaped in profile and requiring only a single joint.

### BRIEF DESCRIPTION OF THE DRAWINGS

FIG. 1, referenced hereinabove, is a three-dimensional view showing a pair of flat oval ductwork sections being joined employing a prior art collar;

FIG. 2, referenced hereinabove, is a sectioned three-dimensional view taken on line 1-1 of FIG. 1;

FIG. 3, referenced hereinabove, is a sectioned three-dimensional view, generally in the same orientation as FIG. 2, showing prior art angle iron flanges joining two ductwork sections;

FIG. 4 schematically depicts a machine embodying the invention for making generally L-shaped flanges for joining sections of either flat oval or round ductwork;

FIG. 5 is a cross-sectional view of ductwork sections being joined employing flanges embodying the invention;

FIG. 6 is a partially broken away end view depicting the positioning of the clips of FIG. 5;

FIG. 7 is a-cross-sectional view depicting flat sheet metal stock material entering the machine of FIG. 4;

FIG. 8 is a cross-sectional view depicting the profile of angled lengths of material following the angle-forming rolls of the machine of FIG. 4;

FIG. 9 is a view similar to FIG. 8, depicting the application of sealant;

FIG. 10 is a longitudinal view of an L-shaped flange embodying the invention for joining sections of round ductwork;

FIG. 11 is a longitudinal view of a flange embodying the invention for joining sections of flat oval ductwork;

FIG. 12 is a cross-sectional view depicting an alternative configuration of clip and angle for joining ductwork sections;

FIG. 13 is a view of the angle of FIG. 12 in isolation;

FIG. 14 is a cross-sectional view of the clip of FIG. 12, in isolation;

FIG. 15 is a side elevational view of a set of shaping rolls included in a particular embodiment of the invention;

FIG. 16 is a top plan view taken on line 16-16 of FIG. 15;

FIGS. 17, 18 and 19 are top plan views depicting the shaping rolls of FIGS. 15 and 16 at several stages during operation;

FIG. 20 depicts a blank of stock material;

FIG. 21 is a cross section of the FIG. 20 blank in a region where there is a cutout, subsequent to angle forming but prior to shaping;

FIG. 22 is a cross section of the FIG. 20 blank in a full-width region, subsequent to angle forming but prior to shaping;

FIG. 23 is a cross section corresponding to (and identical to) FIG. 21, after shaping;

FIG. 24 is a cross section corresponding to FIG. 22, after shaping; and

FIG. 25 depicts a resultant flange.

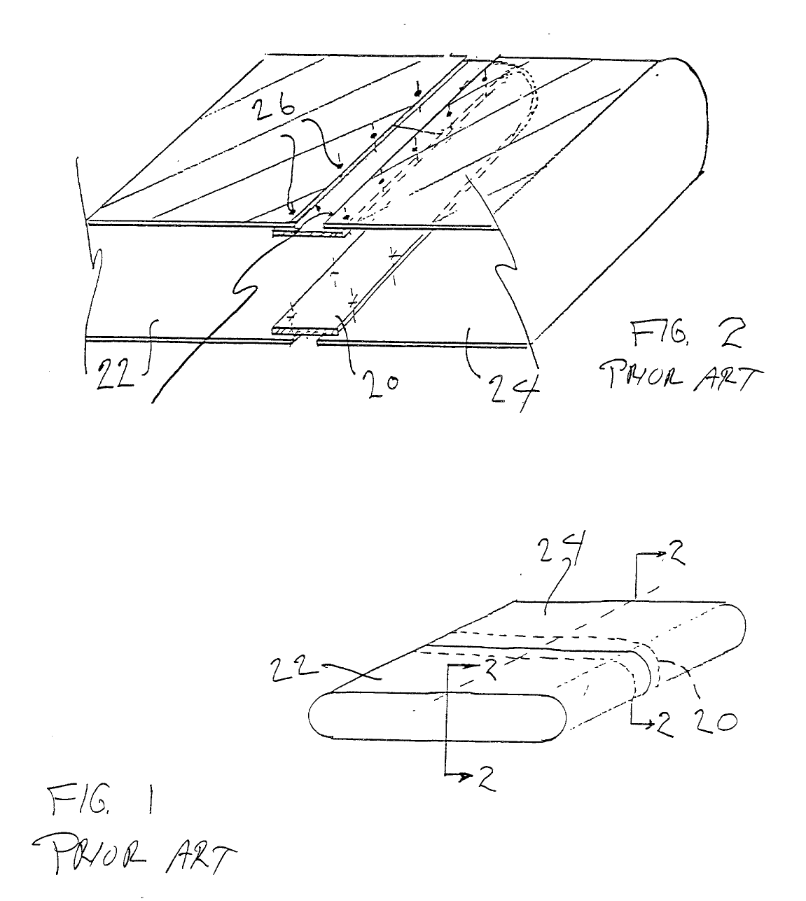

### DESCRIPTION

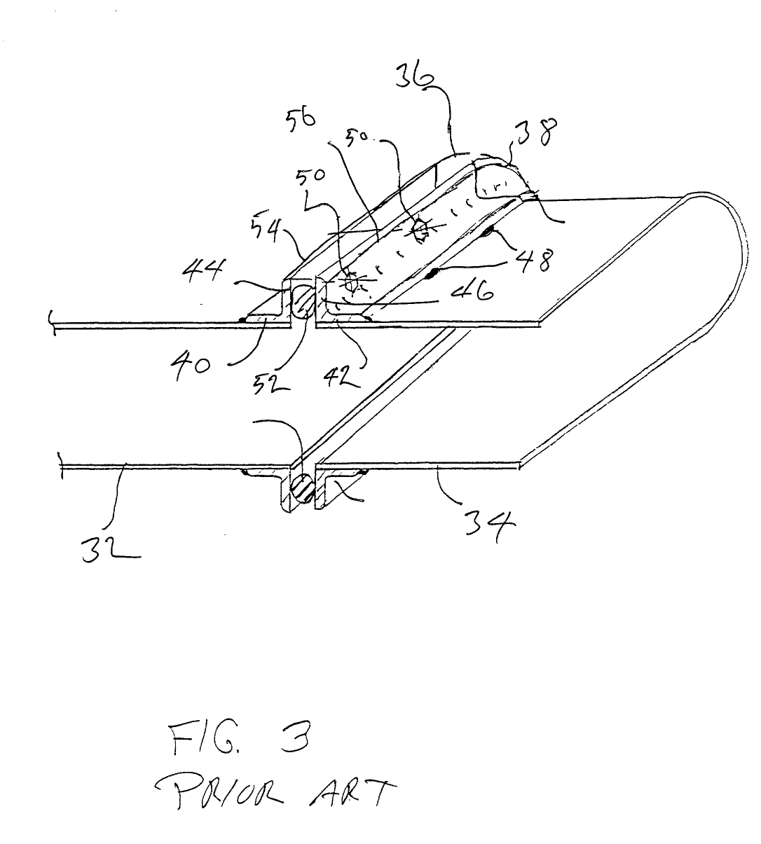

Flange assemblies embodying the invention in general are an alternative to the second known technique briefly summarized above with reference to FIG. 3.

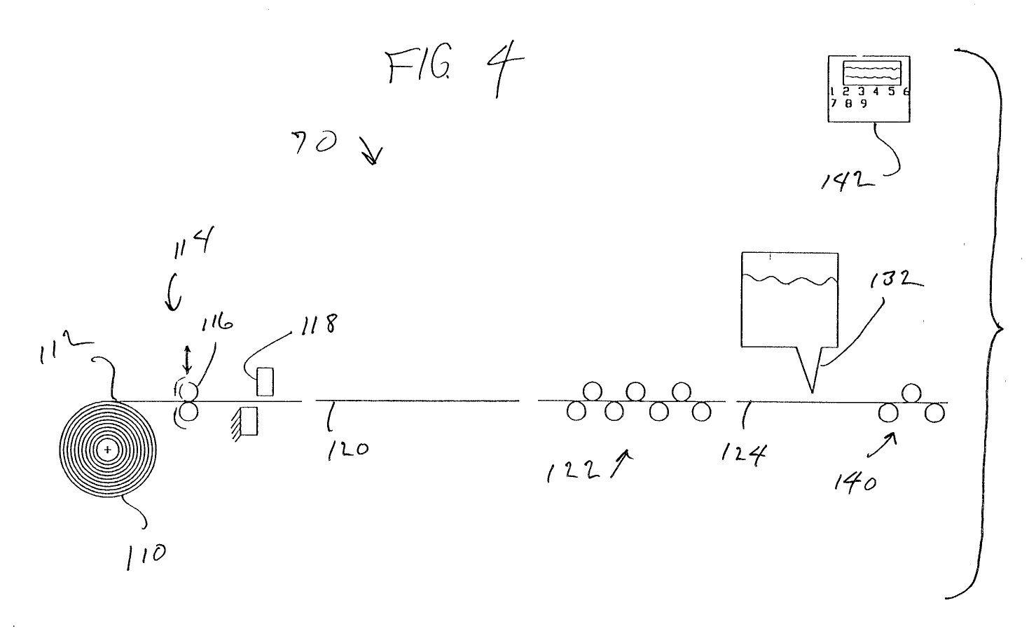

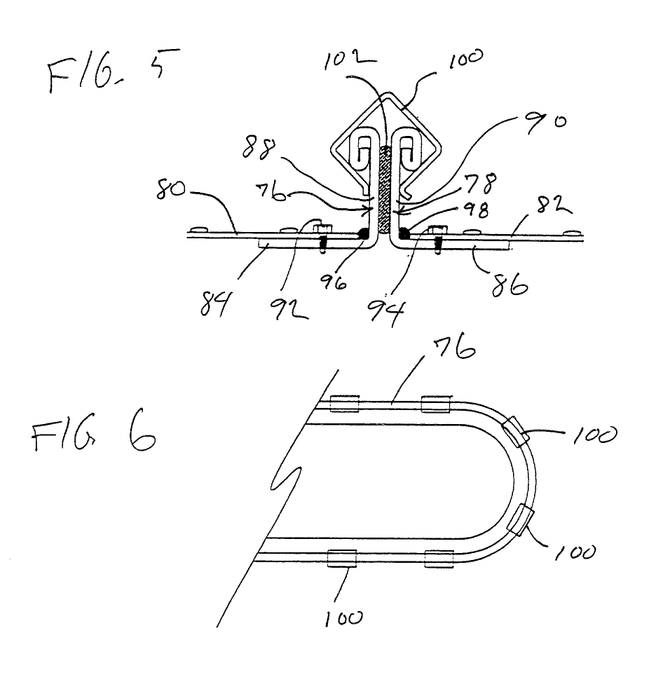

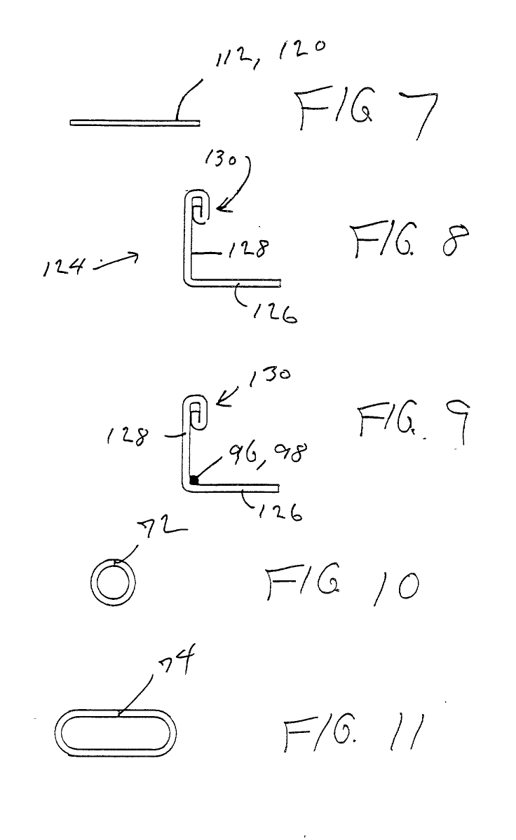

Referring to FIG. 4, schematically depicted is a machine 70 embodying the invention which makes generally L-shaped angled flanges for joining sections of round or flat oval ductwork from a single length of coiled steel stock. Each flange requires only a single joint 72 (FIG. 10) or 74 (FIG. 11).

As depicted in FIGS. 5 and 6, generally L-shaped flanges 76 and 78 are used to connect two sections 80 and 82 of flat oval or spiral ductwork, and/or fittings together. The flanges 76 and 78 have L-shaped profiles defined by respective duct-attachment legs 84 and 86 extending generally parallel to the longitudinal axis of the ductwork sections 80 and 82 being joined, and by respective flange-attachment legs 88 and 90 extending radially outwardly generally perpendicularly to the longitudinal axis of the ductwork sections 80 and 82 being joined. The duct-attachment legs 84 and 86 of the flanges 76 and 78 are secured to the two ductwork sections 80 and 82 with screws 92 and 94. Sealing is aided by beads of sealant 96 and 98. The flange-attachment legs 88 and 90 of the flanges 76 and 78 are secured to each other by clips 100. Mastic 102 is used between facing surfaces of the flanges 76 and 78.

In FIG. 4, a reel 110 supplies coiled steel stock 112 detailed in FIG. 7. An exemplary thickness is 0.0747 inch. The machine 70 has an input section 114 which receives the stock material. In particular, pinch rolls 116 grip the steel 112 as it is unwound from the reel 110.

The steel 112 is fed to cutter 118 such as a shear 118, which accurately cuts pieces of steel stock lengths 120 corresponding to the individual flanges being made. Thus, the lengths are determined by the desired final flange 76, 78 dimensions.

Next, a set 122 of angle-forming rolls forms each length 120 of sheet metal stock material into an angled length 124 of material having a generally L-shaped profile. A cross-sectional representation of each angled length 124 as it emerges from the angle-forming rolls 122 is depicted in FIG. 8, corresponding to the cross-sectional profile of the flanges 76 and 78. A duct-attachment leg 126 and a flange-attachment leg 128 are each approximately one inch long, and an edge roll 130 on the flange-attachment leg 125 is ⅜ inch long.

As a matter of convenience additional forming rolls (not shown) may be included with the angle-forming rolls 122, mounted opposite the angle-forming rolls 122, to manufacture clips 100 (FIGS. 5 and 6).

A sealant applicator 132 injects the sealant 96, 98 into the corner of the angled lengths 124, the result of which is depicted in FIG. 9.

Next, a set 140 of shaping rolls forms the angled lengths 124 of material into either flat oval or round flanges generally L-shaped in profile and requiring only a single joint. Thus, the shaping rolls 140 determine the final overall shape of the flange assembly 76, 78, such as round (FIG. 10) or flat oval (FIG. 11). Preferably the shaping rolls 140 are adjustable on the fly. In the case of a flange for round ductwork sections (FIG. 10), the diameter is determined in conjunction with the length determined by the shear 118. In the case of flat-oval (FIG. 11) the minor and major axis are determined in conjunction with the length as determined by the shear 118.

Overall operation of the machine 70 is directed by a controller 142, which calculates the necessary length of the flange 76, 78 assembly, the required positioning of the adjustable shaping rolls 140, and the quantity of components required.

Although the length 120 of steel stock and the angled length 124 are shown in isolation on either side of the angle forming rolls 122, this depiction is for clarity of illustration. In a practical machine 70, one stage can merge directly into a subsequent stage.

After a flange is formed, its two ends can be joined together in a variety of ways, either before or after insertion into a ductwork section. The two ends can be welded to each other. They can be riveted or otherwise fastened to each other (if overlapped) or to the ductwork and a reinforcement scab if not overlapped. In general, the round or flat oval flanges are inserted into the respective ends of ductwork sections to be joined, and the duct-attachment legs are attached to the respective ductwork sections. The flange-attachment legs are butted against each other, typically with an intermediate seal, and then fastened to each other.

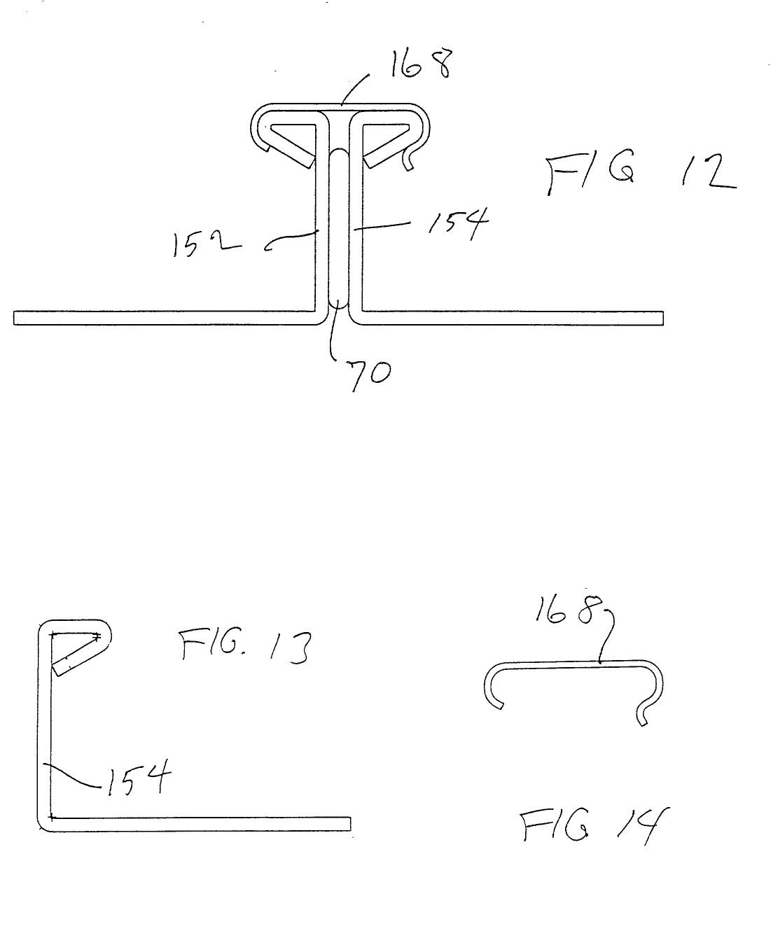

FIGS. 12, 13 and 14 depict alternative configurations to the clip and angle of FIGS. 5 and 8. In FIGS. 12 and 13 flanges 152 and 154 have a modified profile compared to the flanges 76 and 78 of FIG. 5, and in FIGS. 12 and 14 clip 168 has a modified profile compared to the clip 100 of FIG. 5.

Referring next to FIGS. 15 and 16, illustrated is a particular embodiment of a set of shaping rolls for forming the angled lengths of material into flat oval flanges generally L-shaped in profile and requiring a single joint. In particular, FIGS. 15 and 16 depict a form of curling machine 200, particularly useful in forming flanges less than eight inches in diameter.

The curling machine 200 includes upper and lower rolls 202 and 204, and the lower roll 204 is driven through suitable gearing by a motor 206. The spacing between the rolls 202 and 204 is adjustable, by means of an adjustment 208. The rolls 202 and 204 can rapidly be adjusted in spacing, automatically by the controller 142. In addition, there is a freely-turning vertical guide roller 210.

As shown in the side elevational view of FIG. 15 an angled length of material 212 (shown in cross section) having a duct-attachment leg 214 and a flange-attachment leg 216 passes between the rollers 202 and 204 such that the flange-attachment leg 216 is deformed by rolling to a reduced thickness along selected portions of the length where curvature or curling is required.

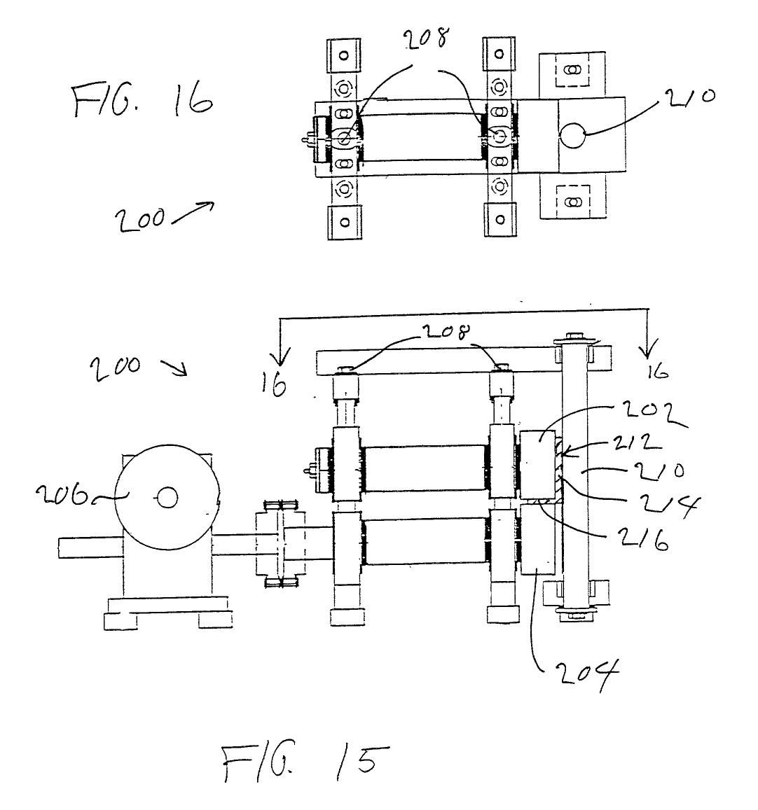

Thus, with reference to FIG. 17, the length 212 of angled material is fed between the rollers 202 and 204 with the spacing between the rollers 202 and 204 set such that deforming of the flange-attachment leg 216 does not occur, initially producing a straight section.

Next, as depicted in FIG. 18, under control of the controller 142, the rolls 202 and 204 are brought closer together, thereby rolling the flange-attachment leg 216 to a reduced thickness, to effect the desired degree of curling or curvature.

For a subsequent straight section, the spacing between the rollers 202 and 204 is again relaxed.

For the next curved section, the rollers 202 and 204 are again brought closer together, forming the final curved end section, resulting in a flat oval flange 220 requiring only a single joint 222, as shown in FIG. 19.

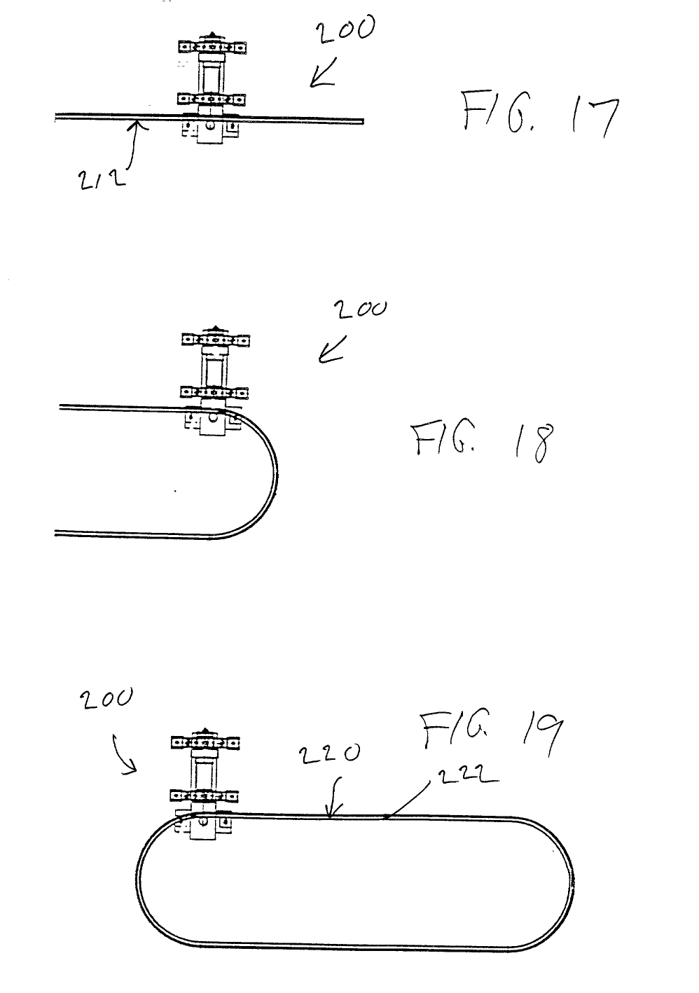

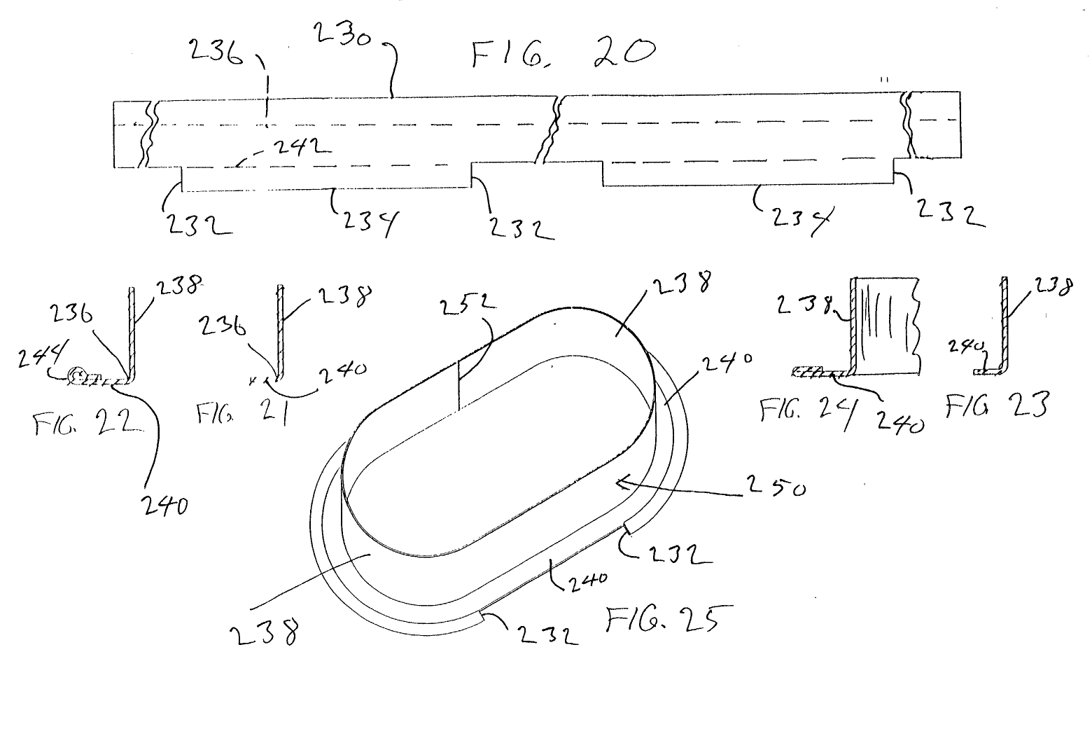

Referring finally to FIGS. 20-25, depicted is an embodiment where the stock material is formed into blanks prior to rolling in a manner which does not require any on-the-fly adjustment of the rollers 202 and 204 to achieve a flat oval flange.

The blank 230 of FIG. 20 has cutouts 232 corresponding to the straight sections of flat oval flanges to be made. The remaining portions 234 correspond to the curved end sections of the flat oval flanges to be made. The cutouts 232 are formed by a notcher (not shown) associated with the FIG. 4 cutter 118.

Within the angle-forming rolls 122 (FIG. 9), the blank 230 is folded 90° along fold line 236 to define a duct-attachment leg 238 and a flange-attachment leg 240. In addition, along fold line 242 the blank 230 is folded in regions between the cutouts 232 to form a rounded edge 244.

The flange-attachment leg 240 is then run between the rollers 202 and 204, which can remain at a fixed spacing. The spacing between the rollers 202 and 204 is such that no deformation occurs when portions of the flange-attachment leg 240 adjacent the cutouts 232 are passing through such that there is no increased material thickness as in FIG. 21 resulting in no change as in FIG. 23. However, the requisite deformation and resultant curling occur when portions of the flange-attachment leg 240 having increased thickness due to the folded-over portions as in FIG. 22, resulting in flattening of the rounded edge 244 and curling as in FIG. 24.

FIG. 25 depicts the result. The flat-oval flange 250 is made of a single piece of metal requiring only a single joint 252. The joint 252 corresponds to the two ends 254 and 256 of the FIG. 20 blank 230.

The subject invention accordingly provides a number of advantages.

Rather than conventional angle iron stock which typically is available in twenty foot lengths, low cost coiled steel is used. Scrap is essentially eliminated.

Sealant 94, 96 is pre-applied to the flanges 76, 78. This allows the joint to be assembled without having to manually apply duct-to-flange sealant.

With flat oval flanges, only one seam is required. In contrast, the second known technique described above (FIG. 3), requires four seams to join the four pieces of flange for a flat-oval flange.

The clips 100 allow the flanges 76, 78 to be attached to each other without having to line up bolt holes and without having to use cumbersome wrenches and pliers to fastened ductwork sections together.

The lighter weight material makes the flange 76, 78 easier to handle, and less costly as less steel is used. At the same time, the triple thickness of the material (124, FIG. 8) after the angle-forming rollers 122 provides added strength and stiffness.

The flanges 76, 78 fasten directly to the sheet metal ductwork sections 80 and 82 (or fittings), without the need for predrilled holes or welding the flange to the ductwork.

Similarly, with the clip assembly 100, the flanges 76, 78 do not have to have bolt holes line up perfectly as is required in the conventional flange of FIG. 3.

The machine thus forms flat coiled steel into an angle profile that is used to join round and flat oval ductwork and fittings. The inner radius of the angle has a sealant applied to it that serves as a gasket for the sealing of the ductwork to the flange. The formed angle flange slips into the ductwork/fitting and seals against the sealant. After the flange is secured by screwing it to the ductwork, a gasket is applied to the flat edge of the flange, the flanges are butted together and a connector clip is installed.

The machine is computer controlled and can be programmed to operate and produce any diameter of round and flat oval shapes.

Previously, the connector methods have been to use either a slip coupling or handmade flange assembly. The slip connector only works for small to medium size ductwork that is carrying low pressure. The flange method is timely to produce and requires extensive sealing after the joint is made.

The subject invention utilizes simple gasketing material to avoid the labor intensive process of duct sealing.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. A machine for making generally L-shaped flanges for joining sections of flat oval ductwork, said machine comprising:
an input section for receiving a strip of sheet metal stock material;
a cutter for cutting the sheet metal stock material into lengths corresponding to individual flanges being made;
a set of angle-forming rolls for forming each length of sheet metal stock material into an angled length of material having a generally L-shaped profile; and
a set of shaping rolls for forming the angled lengths of material into flat oval flanges generally L-shaped in profile and requiring only a single joint.

2. A machine for making generally L-shaped flanges for joining sections of flat oval ductwork, said machine comprising:
an input section for receiving a strip of sheet metal stock material;
a cutter and a set of angle-forming rolls for making out of the strip of sheet metal angled lengths of material having a generally L-shaped profile, the angled lengths of material having lengths corresponding to individual flanges being made; and
a set of shaping rolls for forming the angled lengths of material into flat oval flanges generally L-shaped in profile and requiring only a single joint.

3. A machine for making generally L-shaped flanges for joining sections of round ductwork, said machine comprising:
an input section for receiving a strip of sheet metal stock material;
a cutter for cutting the sheet metal stock material into lengths corresponding to individual flanges being made;
a set of angle-forming rolls for forming each length of sheet metal stock material into an angled length of material having a generally L-shaped profile; and
a set of shaping rolls for forming the angled lengths of material into round flanges generally L-shaped in profile and requiring only a single joint.

4. A method for joining sections of flat oval ductwork, comprising:
providing a pair of flat oval flanges generally L-shaped in profile, each of the flanges being made of a single piece of metal requiring only a single joint, the L-shaped profile being defined by a duct-attachment leg generally parallel to the longitudinal axis of ductwork sections to be joined and by a flange-attachment leg extending radially outwardly generally perpendicularly to the longitudinal axis of the ductwork section to be joined;
inserting the flat oval flanges into the respective ends of the ductwork sections to be joined, and attaching the duct-attachment legs to the respective ductwork sections; and
butting the flange-attachment legs of the flat oval flanges against each other, and fastening the flange-attachment legs to each other.

5. The method of claim 4 wherein said step of fastening the flange-attachment legs to each other comprises employing clips.

6. A connector for joining sections of flat oval ductwork comprising a pair of flat oval flanges generally L-shaped in profile, each of the flanges being made of a single piece of metal requiring only a single joint, the L-shaped profile being defined by a duct-attachment leg generally parallel to the longitudinal axis of ductwork sections to be joined and by a flange-attachment leg extending radially outwardly generally perpendicularly to the longitudinal axis of the ductwork sections to be joined.

7. The connector of claim 6, which further comprises a set of clips for fastening said flange-attachment legs of said flanges to each other.
